(19) United States
(12) Patent Application Publication
(10) Pub. No.: US 2011/0265378 A1
(43) Pub. Date: Nov. 3, 2011

(54) Truncated Reflector

(76) Inventor: Kevin Callaway, Yancy, TX (US)

(21) Appl. No.: 13/183,915

(22) Filed: Jul. 15, 2011

(51) Int. Cl. A01G 1/00

(52) U.S. Cl. 47/1.1 R

(57) ABSTRACT

A Truncated Reflector reflects a targeted spectrum of electromagnetic radiation upwards to irradiate the bottom surfaces of leaves of a plant. The Reflector, which can diffusely reflect the targeted spectrum, can be removably fitted around the base of a plant, and can be adjusted, through various forms of attachment, to allow the Reflector to be adjusted into various truncated parabolic shapes or truncated shapes of other quadric surfaces. Various embodiments of the Reflector can reduce the need for environmentally hazardous chemicals by collecting and delivering water to root zones without splashing potentially contaminated water and soil onto the plant.

### FIELD

The present disclosure relates in general to farming and gardening, and more particularly to devices used to stimulate plant growth and reduce soil splash

### BACKGROUND

Soil in which commercial crops like tomatoes or strawberries are planted often contains viruses, fungi, and nematodes. Commercial farms often treat the soil with Methyl Bromide to kill the viruses, fungi, and nematodes. Treating the soil with Methyl Bromide and other chemicals reduces the likelihood of any soil splashed on the plants' leaves from transferring pathogens to the crops. Unfortunately, many of these chemicals are potentially environmentally hazardous. For example, Methyl Bromide is a known ozone-depleting substance (ODS) and is classified by the United States Environmental Protection Agency as a Class I ODS.

Various mulches and ground-cover films can be used to lessen soil splash, but the mulches and ground-cover films are often used in conjunction with chemicals such as Methyl Bromide. Furthermore, ground-cover films can prevent or decrease the amount of water delivered to the root zone of the plant, and mulches can be washed away, thereby rendering them ineffective to prevent soil splash.

Mulches and ground-cover films be used to change the amount and type of light reflected onto the commercial crops, which may affect a plants' growth and yield. For example, the development of some plants has been found to be influenced by different spectra of light reflected from differently colored surfaces, such as Colorized Reflective Mulch films and other colored ground cover films.

Specially-colored mulches are sometimes used to favorably influence a plant's development or repel pests, but are not necessarily effective at directing reflected light onto the crops. Ground cover films are translucent or semi-opaque, which causes the frequency of light reflected by the films to vary depending on the color of the soil over which the film is installed.

Furthermore, mulches and other ground cover films may not be easily handled or transported. For example, colored mulches may need to be scooped up at various times of the year, which can be a cumbersome process. In addition, other ground cover films, which may be perforated to allow a plant to grow through the film, may need to be carefully separated from the plant before being carefully rolled for transportation, or the ground cover films may simply be written off as single-use apparatii and destroyed, thereby precluding their reusability and wasting resources.

Thus, specially-colored mulches and other ground cover films, although well suited for some farming or gardening operations, are less than ideal for others.

### SUMMARY

Various embodiments of the present disclosure allow a device configured to reflect a targeted spectrum of electromagnetic radiation upwards to irradiate the bottom surfaces of leaves of a plant.

In one aspect of the disclosure, an apparatus includes a generally circular sheet of material having a reflective side adapted to reflect a targeted spectrum of electromagnetic radiation upwards to irradiate the underside of one or more leaves of a leafy plant. The reflective side can diffusely reflect the targeted spectrum. The sheet of material has a central opening generally at its center that can be placed around the base of a leafy plant and a slit that extends from the central opening that enables the two parts of the sheet on opposite edges of the slit to be adjustably joined together, bending the sheet into the shape of a truncated quadric surface. The two parts can be joined by one or more pairs of tabs and slots on opposite parts of the sheet on opposite edges of the slit. The two parts can also be joined by one or more pairs of snap closures adapted to couple to each other or one or more adhesive tabs or pairs thereof adapted to couple to each other. The sheet can also have one or more holes that receive one or more parts of a support member of a leafy plant support structure.

The apparatus can include a cover that cooperates with the sheet to funnel water down the truncated quadric surface and under the cover to minimize soil splash. The cover can have a central opening and a slit and can be fitted around the base of the plant. The cover can be shaped and sized to substantially cover the sheet's central opening. One or more reflective surfaces adapted to repel or antagonize pests in proximity to the at least one leafy plant from the at least one leafy plant can be attached to the sheet of material.

In another aspect of the disclosure, an apparatus for stimulating plant growth includes an outer dish and a cover. The outer dish is generally in the shape of a truncated code with an inner surface, outer surface, open top, and open bottom, and is placed around a plant so that the inner surface reflects a targeted spectrum of electromagnetic radiation upwards to irradiate a bottom surface of a leaf of the plant and allows diffuse reflection of a targeted spectrum of light. The apparatus also includes a cover for the open bottom. The outer dish, the cover, a combination thereof, or the like can shade soil proximate to the plant. The cover has an opening to allow the cover to be placed around the base of the plant, is shaped and sized to cover the open bottom of the outer dish, and cooperates with the outer dish to funnel water down the inner surface to roots of the plant, while minimizing soil splash.

The outer dish can have a slit extending generally from the open top to the open bottom so that part of the outer dish near one edge of the slit can be joined to another part near another edge of the slit, thereby bending the outer dish into a shape having a truncated quadric surface. The parts can be joined by one or more adhesive tabs or pairs thereof adapted to couple to each other, or by one or more tabs on one part coupled a corresponding one or more slots on the other part. One or more reflective surfaces adapted to repel pests from the plant can be coupled to the outer dish. The outer dish of can have one or more holes to receive one or more parts of a support member of a plant support structure. The outer dish can also have one or more substances to mitigate the reflection of spectra other than a targeted spectrum of light.

In another aspect of the disclosure, a reflector for use in growing plants includes an adjustable funnel and an apex cover. The adjustable funnel has a mouth, an apex, and a generally parabolic surface to reflect a substantially limited spectrum of light onto a bottom surface of a leaf of a plant about which the adjustable funnel is placed, and it can facilitate diffuse reflection of the substantially limited spectrum. The apex cover can be placed around a base of the plant and can substantially cover an opening in the apex. Both the apex cover and the adjustable funnel cooperate to funnel water to roots of the plant while minimizing soil splash.

### BRIEF DESCRIPTION OF THE DRAWINGS

Aspects of this disclosure will become apparent upon reading the following detailed description and upon reference to the accompanying drawings, in which like references may indicate similar elements:

FIG. 1 is a plan view of a truncated parabolic reflector according to various embodiments of the present disclosure;

FIG. 2 is a perspective view of a truncated parabolic reflector with a breakout showing a surface configured to facilitate diffuse reflection according to various embodiments of the present disclosure;

FIG. 3 is a perspective view of a truncated parabolic reflector installed around a plant according to various embodiments of the present disclosure;

FIG. 4 is a perspective view of a truncated parabolic reflector installed around a plant according to various embodiments of the present disclosure;

FIG. 5 is a perspective view of an adjustable truncated parabolic reflector according to various embodiments of the present disclosure;

FIG. 6 is a plan view of a truncated parabolic reflector according to various embodiments of the present disclosure;

FIG. 7 is a perspective view of a truncated parabolic reflector according to various embodiments of the present disclosure; and

FIG. 8 is a diagram of a surface of a truncated parabolic reflector according to various embodiments of the present disclosure.

### DETAILED DESCRIPTION

The following is a detailed description of embodiments of the disclosure depicted in the accompanying drawings. The embodiments are described in such detail as to clearly communicate to one of ordinary skill how to make and use the claimed invention. However, the amount of detail offered is not intended to limit the anticipated variations of embodiments; on the contrary, the intention is to cover all modifications, equivalents, and alternatives falling within the spirit and scope of the present disclosure as defined by the appended claims.

A Truncated Quadric Reflector (“Reflector”) according to various embodiments can be used to stimulate plant development by reflecting a predetermined or user-defined spectrum (herein referred to as a “targeted spectrum”) of electromagnetic radiation (“light”) upwards to irradiate the bottom surfaces of the leaves of a plant around which the Reflector is placed. Such upwards irradiation could stimulate one or more of a plant's growth, foliage development, fruit yield, or the like by stimulating components of the plant including, but not limited to, photoreceptors such as phytochrome, carbon allocation, or the like which can regulate some or all of a plant's development. Stimulating a plant's development can lead to larger plants with greater yield per plant, increased transpiration rates per plant from increased foliage, and the like.

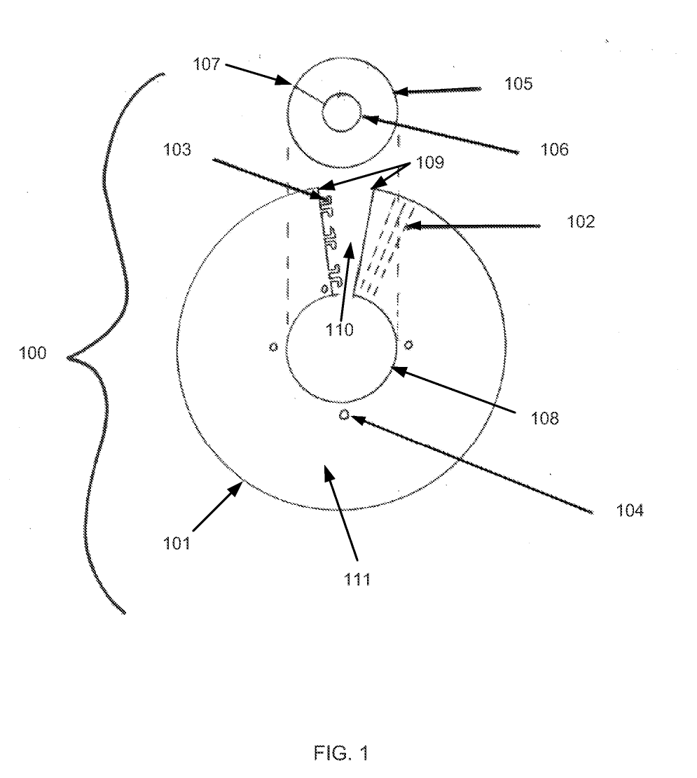

Referring first to FIG. 1, embodiments of a Truncated Quadric Reflector (“Reflector”) 100 are illustrated and discussed. FIG. 1 illustrates a plan view of Reflector 100 which is adapted to reflect a targeted spectrum of incident light upwards to irradiate some or all of the leaves on a plant (not shown) that Reflector 100 is placed around, under, or the like. In some embodiments, Reflector 100 can also serve as a mechanical mulch to provide shade to soil, a mechanical repellent against pests, and the like. Reflector 100 can, in some embodiments, include a sheet of material (“sheet”, also referred to herein as an “outer dish” or “funnel” or “adjustable funnel”) 101 and cover 105.

Reflector 100 can reflect incident light, which can include, but is not limited to, sunlight or other projections of electromagnetic radiation onto a plant, including light from a man-made source such as an ultraviolet or infrared lamp. Reflector 100 can boost the irradiation of the leaves of the plant, including the undersides of the plant's leaves, by focusing incident light on a point or more general region of space. For example, in some embodiments, sheet 101 can be shaped like a quadric surface that can reflect incident light reaching the sheet 101 into a region of space that contains some or all of a plant. In some embodiments, sheet 101 is constructed with one or more materials including, but not limited to, plastic, polycarbonate plastic, water-resistant paper, metal, wood, or the like. Materials used to construct the sheet 101 can include, but are not limited to, recycled feed stock, virgin materials, a combination, or the like.

In some embodiments, Reflector 100 can be adapted to focus reflected light generally upwards onto a certain region of space including a specific point, axis, or region. In some embodiments, Reflector 100 is adapted to focus reflected light by its shape. For example, sheet 101 may have a generally inverted conical shape that will reflect incident light into a region of space generally above Reflector 100. In some other embodiments, sheet 101 has the general shape of an upwards parabolic reflector, which can include, but is not limited to, the general shape of a paraboloid, such that any incident light is reflected substantially towards a single point in space above Reflector 100. As used herein, the term “parabolic” refers to a shape similar to, although not necessarily identical to, a parabola, paraboloid, or the like.

In some embodiments, sheet 101 can be shaped to serve as a mechanical pest deterrent to repel pests including, but not limited to, rodents, birds, and the like. Sheet 101 can also serve as a mechanical mulch, providing shade to soil near a plant. Shading soil near a plant can prevent excess water evaporation, thereby reducing the need for excess watering of plants and conserving water resources. In addition, shading the soil can reduce the need for excess fertilizers, which also prevents excessive runoff of potentially environmentally hazardous fertilizers, by preventing evaporation or volatilization of existing fertilizer from the shaded area.

In some embodiments, the quadric shape of the sheet 101 can be “truncated” such that part of sheet 101 is absent. For example, a sheet 101 having a generally conical or parabolic shape may be truncated by having a central hole 108 substantially where the apex of the cone or paraboloid would be, respectively. As used herein, sheet 101 can include, but is not limited to, a piece of material that has the general outline of a circle, ellipse, oval, polygon, or the like. In some embodiments, sheet 101 can include a central hole 108 located substantially at its geometric center or centroid. For example, in the illustrated embodiment, sheet 101 has the general outline of a circle, and includes a central hole 108 located at or near the geometric center or centroid of sheet 101 through which a plant can extend. Central hole 108 can accommodate the full diameter of the base of the plant. In some other embodiments, including but not limited to embodiments where the plant is in a container, sheet 101 can be coupled to or placed beneath the container.

In some embodiments, sheet 101 has two or more sides including, but not limited to, an inner surface 111 that faces generally upwards towards the plant and an outer surface that faces generally downward. In some embodiments, inner surface 111 is reflective so that one or more spectra of incident light can be reflected from inner surface 111 upwards to irradiate part or all of a plant, which can include, but is not limited to, the undersides of leaves of the plant. In some embodiments, inner surface 111 is adapted to reflect a specific targeted light spectrum. For example, in embodiments where the irradiation of the leaves of a plant by red light is desired, inner surface 111 may be adapted to reflect only a certain targeted spectrum or spectra of light that includes substantially only long-wavelength visible light including, but not limited to, red light. In some other embodiments, where only a very specific wavelength of light is desired to irradiate the leaves of the plant, inner surface 111 is adapted to reflect substantially only the specific wavelength of light. In some other embodiments, where general reflection of non-specific wavelengths, including any and all incident light, is desired, inner surface 111 is adapted to reflect any and all incident light.

In some embodiments, the material that makes up sheet 101 can be impregnated with chemical compounds to eliminate, stabilize, or reduce the reflection of light spectra beyond the targeted light spectrum, or the like. In some embodiments, the chemical compounds can be incorporated into, molded into, painted, grafted, or the like onto or into some or all of the material that makes up sheet 101. The chemical compounds can, in some embodiments, be introduced into or onto the Reflector to produce specific results with respect to plant physiology or plant development response that may be tailored to one or more specific plants.

In some embodiments, sheet 101 can include one or more holes 104 that into which or through a support member of a plant support structure can extend. For example, in the illustrated embodiment, sheet 101 includes four holes 104 that can receive a support member. Plant support structures can include, but are not limited to, stakes, rebar, vegetable cages, and the like.

Various embodiments of sheet 101 include a slit 110 that extends partially or fully between central hole 108 and the outer edge of sheet 101, or vice versa. In the illustrated embodiment, for example, slit 110 extends fully between central hole 108 and the outer edge of sheet 110. In some embodiments, slit 110 can enable sheet 101 to be more easily placed around the base of a plant.

In some embodiments, slit 110 enables sheet 101 to be adjustably configured into one or more shapes of truncated quadric surfaces with one or more forms of attachment including, but not limited to, tab and slot pairs, adhesives, snap closures, zippers, buttons, Velcro, rib or slot-slide closures, or the like. Where slit 110 extends partially or fully from central hole 108 to the outer edge of sheet 101, one form of attachment may be on or near one edge 109 of the slit 110, and another form of attachment may be on or near another edge 109 of the slit 110. Sheet 101 can be adjusted by coupling one or more forms of attachment on or near opposite edges 109 of slit 110. In some embodiments, one or more forms of attachment can be attached to various points on sheet 101 to enable sheet 101 to be adjusted into various shapes of truncated quadric surfaces. For example, in the illustrated embodiment, sheet 101 includes one or more tabs 103 on one edge 109 which are configured to fit into one or more slots 102 near the opposite edge 109 so that, depending upon which slot 102 a tab 103 is coupled to, sheet 101 will be adjusted into a different shape of truncated quadric surface. In some embodiments, sheet 101 can be configured to be adjustably configured into one of multiple truncated quadric surface shapes by having multiple forms of attachment on or near one edge 109. For example, in the illustrated embodiment, each tab 103 can be fitted into one of three different slots 102 located at various distances from edge 109 so that fitting tab 103 into a different slot 102 will bend sheet 101 into a different truncated quadric surface shape. In some other embodiments, different forms of attachment are used, including, but not limited to, adhesive tabs, snap closures, zippers, buttons, or the like.

In some embodiments, Reflector 100 includes cover 105. Cover 105 can have a shape that is generally circular, elliptical, polygonal, or the like. For example, in the illustrated embodiment, cover 105 has a generally circular shape. Cover 105 can be placed over part of sheet 101 to substantially or fully cover central hole 108. In the illustrated embodiment, for example, cover 105 is configured to be placed to substantially cover central hole 108. Cover 105 can also be placed under part of sheet 101 such that central hole 108 is located substantially over cover 105. Cover 105, in some embodiments, can include a central hole 106, located substantially at its geometric center or centroid, through which a plant extends. For example, in the illustrated embodiment, where Reflector 100 is configured to be placed around the base of a plant (not shown) that extends through central hole 108, cover 105 can be placed substantially over central hole 108 so that the plant extends through central hole 106. In some embodiments, cover 107 can include a slit 107 that extends partially or fully between central hole 106 and the outer edge of cover 105, or vice versa, to enable cover 105 to be more easily placed around a plant. For example, in the illustrated embodiment, cover 105 includes a slit 107 that extends fully between central hole 106 and the outer edge of cover 105.

In some embodiments, cover 105 cooperates with sheet 101 to funnel water down the inner surface of sheet 101, under or around cover 105, and through central hole 108 to the root zone of the plant without splashing back onto the plant as soil splash. In some other embodiments, cover 105 serves as a mechanical mulch to provide shade to the soil near the plant. In some other embodiments, some or all of an inner surface of cover 105 is reflective.

In some embodiments, cover 105 is absent from Reflector 100 to enable improved soil transpiration in wet seasons or climates. Cover 105 can be constructed in, or can be configured into, a truncated quadric shape with a reflective inner surface to irradiate the plant with a targeted light spectrum, repel pests, or the like, essentially becoming a miniature reflector within Reflector 100. In some other embodiments, cover 105 is flat and used as a reflecting surface, mechanical mulch, or the like.

In some embodiments, Reflector 100 can be configured to optimize ease of transport and storage when not in use. For example, one or more materials that make up Reflector 100, such as sheet 101, may be constructed of a material that enables them to be rolled into a tubular shape prior to assembly or after disassembly of Reflector 100. Such a tubular shape can, in some embodiments, optimize the ease of shipment of Reflector 100 in a standard mailing tube. In some embodiments, some or all of Reflector 100 can be configured to be rolled into a tubular shape by being partially or fully made of a flexible material including, but not limited to, polycarbonate plastic. Use of re-useable Reflectors 100 reduces the need to re-purchase them every growing season, thereby conserving resources.

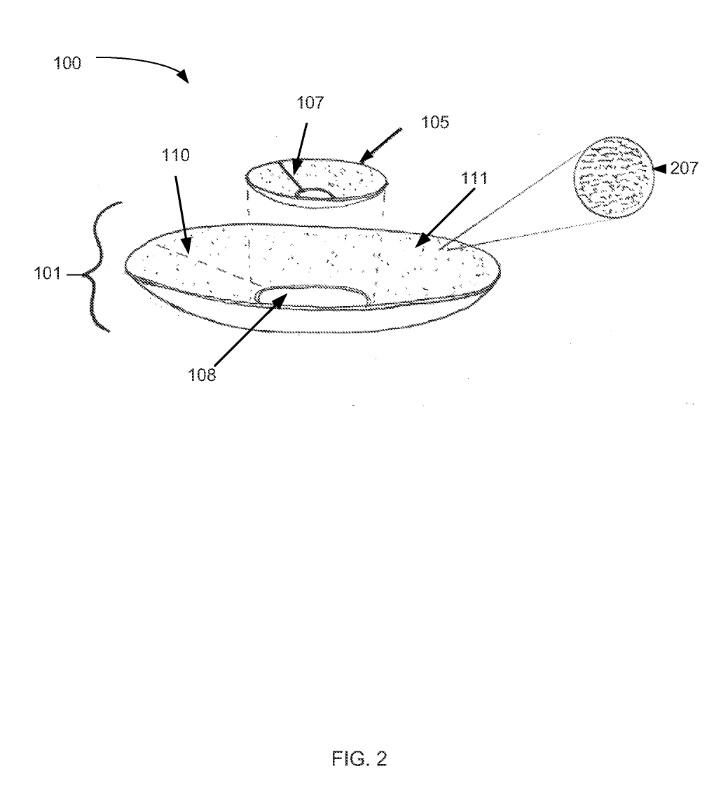

Referring to FIG. 2, embodiments of a Truncated Quadric Reflector (“Reflector”) are illustrated and discussed. FIG. 2 illustrates a perspective view of an embodiment of Reflector 100 that includes sheet 101 and cover 105. In the illustrated embodiment, sheet 101 includes a slit 110 extending fully between a central hole 108 and the outer edge of sheet 101 and can be adjusted into one or more shapes of a truncated quadric surface.

In some embodiments, Reflector 100 is adapted to scatter reflected incident light to irradiate a larger region of space. For example, inner surface 111 of sheet 101 can be adapted to exhibit diffuse reflectance (also referred to as Lambertian reflectance), where incident light falling on inner surface 111 is scattered, uniformly or otherwise, so that the brightness or luminance of inner surface 111 is uniform over a larger region of space. An embodiment of inner surface 111 exhibiting diffuse reflectance may reflect a given wavelength of light in many different directions. In some embodiments where the shape of sheet 101 is generally that of a truncated parabolic reflector, inner surface 111 is adapted to exhibit diffuse reflectance so that reflected light is not focused to a single point in space, but is rather reflected uniformly over a certain region of space. In this way, a larger area of a plant can be irradiated with a targeted light spectrum, rather than just a single point.

Diffuse reflectance can be inherent to inner surface 111 or imparted to inner surface 111 by a coating, paint, film, impregnated chemical, covering, or the like. For example, in the illustrated embodiment, inner surface 111 has surface irregularities 207, which reflect a targeted light spectrum in multiple directions. In some embodiments, surface irregularities 207 can be due to crenellations or micro-crenellations in the inner surface 111. In some other embodiments, inner surface 111 can be configured to have surface irregularities 207 by notching, sanding, bead blasting, polishing, molding, or the like. Surface irregularities 207 can be inherent to the material used to construct sheet 101, or can be layered upon inner surface 111 by a paint, cover, film, or the like. In some other embodiments, inner surface 111 can be adapted to exhibit diffuse reflection even though a surface finish is essentially smooth to the touch. For example, inner surface 111 can be covered by a film or other cover that scatters a targeted light spectrum reflected from inner surface 111 beneath the film or other cover.

In some other embodiments, the material that makes up components of the Reflector 100 can be impregnated covered, coated, or the like with various chemical compounds to increase the stability of pigments used to construct Reflector 100. For example, sheet 101 may be impregnated with Hindered Amine Light Stabilizing Compounds (HALS), Ultraviolet Inhibiting Compounds (UVAS), or the like. In some embodiments, the chemical compounds can be incorporated into, molding into, painted, or grafted onto or into some or all of the materials that make up Reflector 100. In some other embodiments, Reflector 100 has a painted water-resistant clear top coat, a painted water-resistant clear bottom coat.

In some embodiments, cover 105 can be adjustably configured into a truncated quadric surface shape similar to, or different from, the truncated quadric surface shape of sheet 101. In the illustrated embodiment, for example, cover 105 is configured into a truncated quadric surface shape similar to that of sheet 101. In some embodiments, such configuring of cover 105 can be enabled by the coupling of one or more forms of attachment located on or near opposite edges of slit 107. In some embodiments, cover 105 can be configured into a truncated quadric surface shape to reflect a targeted light spectrum upwards to irradiate part or all of a plant, to serve as a photo-repellent, to cooperate with sheet 101 to funnel water into the root zone of the plant with minimal soil splash, serve as a mechanical mulch, and serve as a mechanical pest repellent.

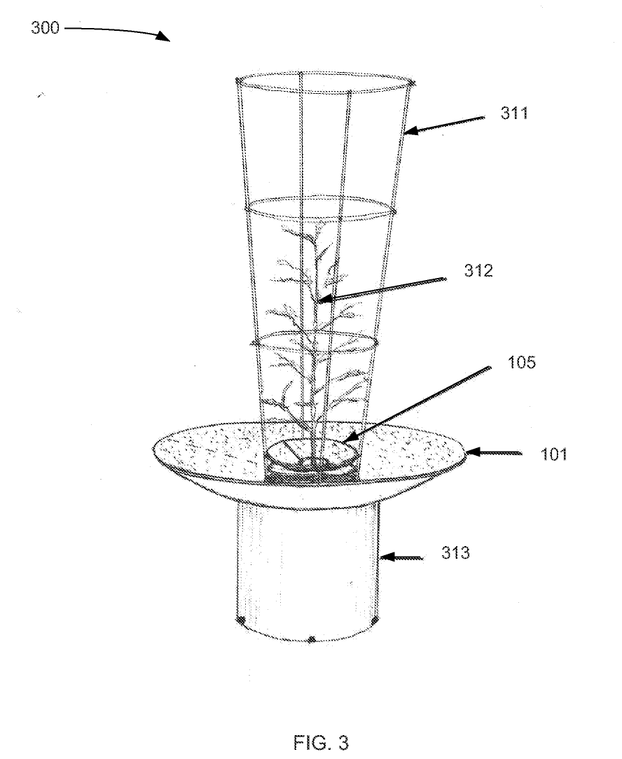

Referring to FIG. 3, embodiments of a Truncated Quadric Reflector (“Reflector”) 300 are illustrated and discussed. FIG. 3 illustrates a perspective view of Reflector 300 in an embodiment where a plant 312 around which Reflector 300 is to be positioned is to be grown in a container 313 such as a planter, flower pot, trough, hydroponic system, or the like. Reflector 300 includes a sheet 101 configured to be coupled with a plant 312 growing in a container 313. In some embodiments, sheet 101 can be coupled to container 313 by one or more forms of attachment to the circumference of container 313 including, but not limited to, tab and slot pairs, adhesives, snap closures, zippers, buttons, Velcro, rib or slot-slide closures, or the like. In some other embodiments, sheet 101 can be placed on top of or beneath container 313. In the illustrated embodiment, for example, sheet 101 is placed on top of container 313. In some other embodiments, container 313 and sheet 101 can be constructed from a single piece of material. Reflector 300 may be adapted to receive the container. For example, Reflector 300 may be configured to allow container 313 to be placed within the central hole of sheet 101.

In some embodiments, Reflector 300 can be adapted to receive or include one or more parts of one or more support members of a plant support structure 311 through one or more openings or holes in sheet 101 or cover 105, through a central hole of sheet 101 or cover 105, or the like. For example, in the illustrated embodiment, plant support structure 311 is a vegetable cage, the support members of which extend through the central hole 108 of sheet 101, illustrated in FIG. 1. The plant support structure, which in some other embodiments can be one or more plant stakes, lengths of rebar, plant cages, some other form of scaffolding, or the like, can provide support to plant 312 as it grows.

In some embodiments, cover 105 can be placed within or supported by plant support structure 311. For example, in the illustrated embodiment, cover 105 is suspended within plant support structure 311. In some embodiments, suspending cover 105 can optimize cooperation between cover 105 and sheet 101 to funnel water into the root zone of plant 312 with minimal soil splash.

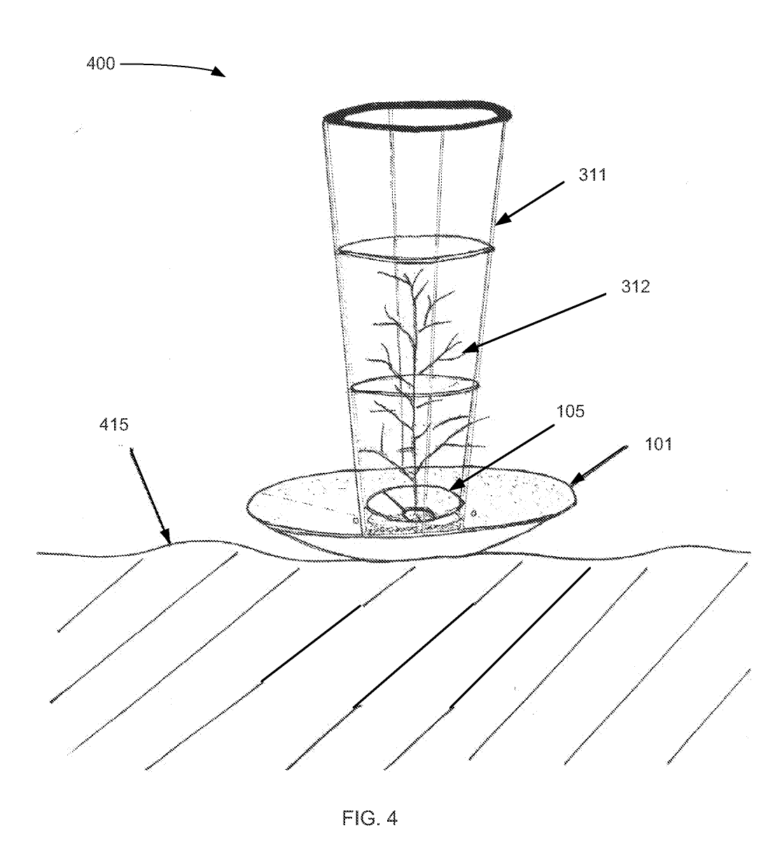

Referring to FIG. 4, embodiments of a Truncated Quadric Reflector (“Reflector”) 400 are illustrated and discussed. FIG. 4 illustrates a perspective view of Reflector 400 in an embodiment where Reflector 400 includes a sheet 101 configured to be coupled with a plant 312 growing from a surface 415, which can include, but is not limited to, topsoil or the like. As discussed above in FIG. 3, sheet 101 can receive one or more support members of a plant support structure 311, and cover 105 can be placed, suspended, or the like within plant support structure 311. As shown in the illustrated embodiment, Reflector 400 can be placed over or around a plant 312 that is growing from a surface 415 including, but not limited to, topsoil. Sheet 101 can serve as a mechanical mulch, a mechanical repellent against pests, or the like. As a mechanical mulch, sheet 101 can provide shade to the soil 415 near the plant 312, thereby reducing the need for excess water, pesticides, fertilizers, and other compounds to replace those lost from evaporation, volatilization, and the like from soil 415. As a mechanical repellent, sheet 101 can reduce or mitigate the antagonizing effects of pests such as rodents, birds, and the like on the development of plant 312.

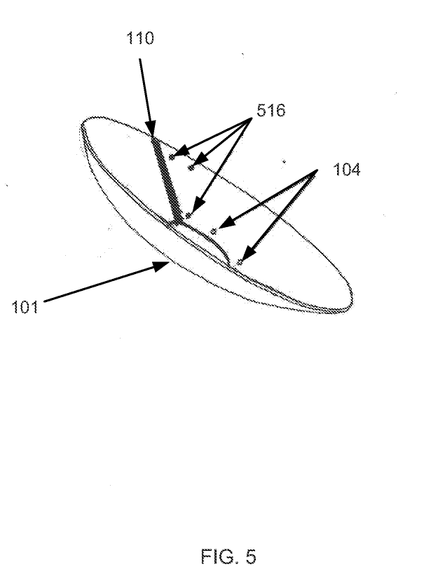

Referring to FIG. 5, embodiments of a Truncated Quadric Reflector (“Reflector”) are illustrated and discussed. FIG. 5 illustrates a perspective view of a sheet 101 of an embodiment of a Reflector where sheet 101, which includes one or more holes 104 in which to receive part of a support member of a plant support structure, is configured to be adjustably configured into one or more truncated quadric surface shapes. In some embodiments, sheet 101 can include a slit 110, discussed and illustrated further in FIG. 1, surfaces on the opposing sides of which are adjustably coupled through one or more forms of attachment. For example, in the illustrated embodiment, surfaces on opposing sides of slit 110 are coupled by three snap closures 516. In some other embodiments, other forms of attachment including, but not limited to, adhesives, zippers, buttons, or the like are used to adjustably couple surfaces of sheet 101 on opposing sides of slit 110.

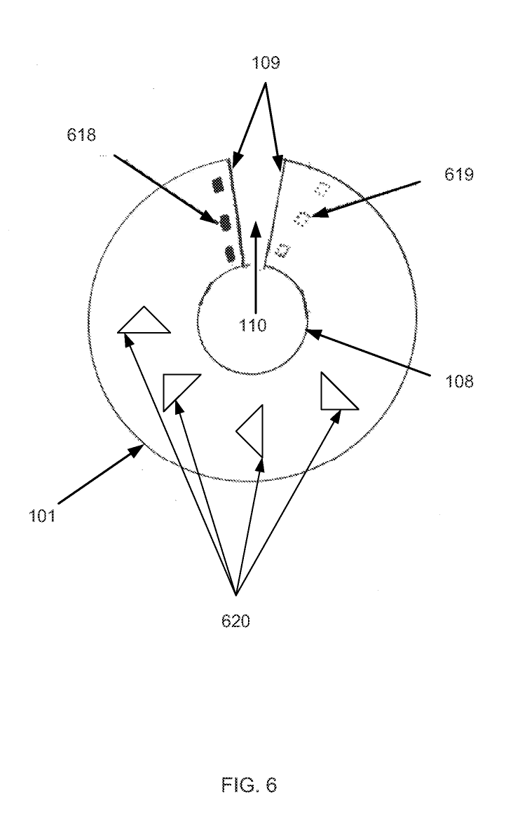

Referring to FIG. 6, embodiments of a Truncated Quadric Reflector (“Reflector”) are illustrated and discussed. FIG. 6 illustrates a plan view of a sheet 101 of an embodiment of a Reflector where sheet 101 is configured to be adjustably configured into one or more truncated quadric surface shapes. In some embodiments, sheet 101 can include a slit 110 extending partially or fully between a central hole 108 and an outer edge of sheet 101, surfaces on or near the opposing edges 109 of which are adjustably coupled through one or more forms of attachment. For example, in the illustrated embodiment, surfaces near opposing edges 109 of slit 110 can be coupled by three pairs of adhesive tabs 618 and 619 to configure sheet 101 into a truncated quadric surface shape. In some other embodiments, other forms of attachment including, but not limited to, snap closures, zippers, buttons, or the like are used to adjustably couple surfaces of sheet 101 on or near opposing edges 109 of slit 110.

In some embodiments, sheet 101 can include one or more photo-repellents 620 configured to deter, repel, or otherwise antagonize pests including, but not limited to, insects, mites, or the like. Photo-repellents (also referred to herein as “photo-antagonists”) 620 can, in some embodiments, include, but are not limited to, reflective surfaces, decals, a coating, a film, a covering, or the like having various shapes and sizes. For example, in the illustrated embodiment, photo-repellents 620 include four triangular reflective decals, which can be adhesive decals, placed on the inner surface of sheet 101 and spaced at various distances from each other. In some embodiments, photo-repellants 620 can be coupled to sheet 101, cover 105 illustrated above in FIG. 1, or the like. In some other embodiments, one or more materials that make up sheet 101 are impregnated with chemicals that impart photo-repellant properties to the surfaces of sheet 101.

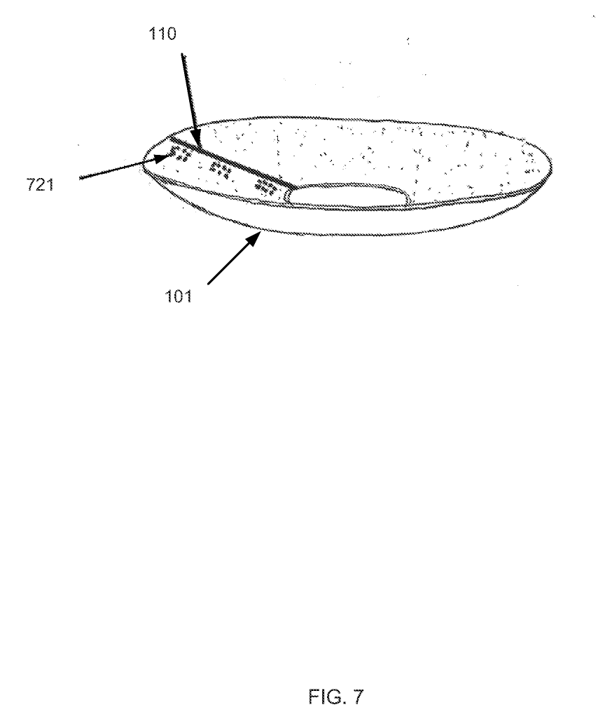

Referring to FIG. 7, embodiments of a Truncated Quadric Reflector (“Reflector”) are illustrated and discussed. FIG. 7 illustrates a perspective view of a sheet 101 illustrated in FIG. 6, where the adhesive tab pairs 721 near opposite edges of slit 110, illustrated and discussed further in FIG. 6, are coupled together to configure sheet 101 into one or more truncated quadric surface shapes. In the illustrated embodiment, sheet 101 is configured into a truncated quadric surface shape that approximates a truncated circular paraboloid. In some other embodiments, sheet 101 can be configured to approximate other truncated quadric surface shapes including, but not limited to, those of a truncated cone, truncated paraboloid, truncated hyperbolic paraboloid, truncated hyperboloid, truncated hyperbolic or parabolic cylinder, or the like.

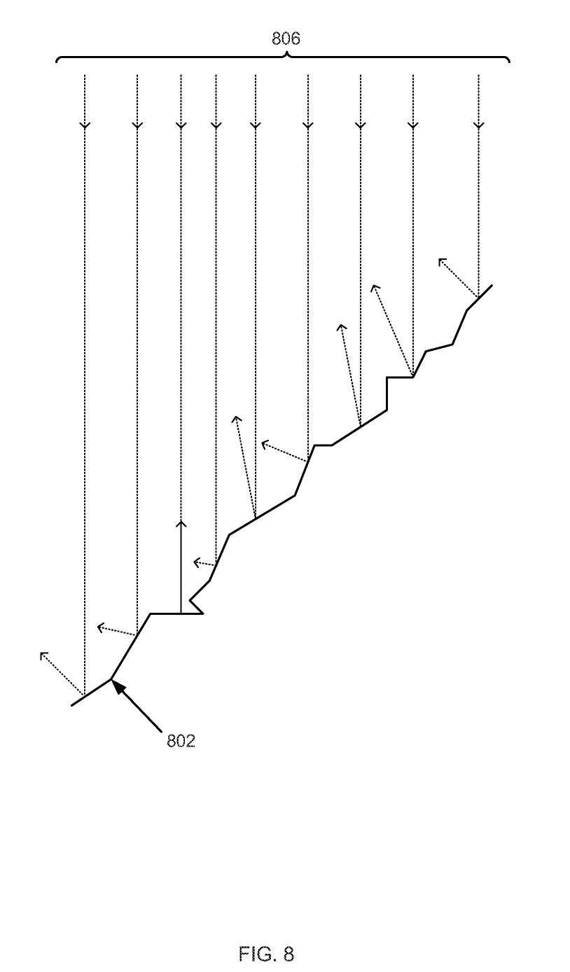

Referring to FIG. 8, embodiments of a Truncated Quadric Reflector (“Reflector”) are illustrated and discussed. FIG. 8 illustrates a diagram of an inner surface 802 of a sheet 101 illustrated and discussed in FIG. 1-7. As shown in the illustrated embodiment, some embodiments of inner surface 802 can be irregular such that incident light 806 reflects uniformly off of inner surface 802 in multiple directions, thereby exhibiting diffuse reflection of one or more spectra of the incident light. For example, an irregular inner surface 802 can reflect a targeted light spectrum in various directions so that the inner surface 802 reflects the targeted spectrum of light to irradiate a larger region of space than if the inner surface was not irregular. Irregularity of the inner surface 802 can be due to crenellations or micro-crenellations in or on the inner surface 802. In some other embodiments, inner surface 802 can be configured to be irregular by being notched, sanded, bead blasted, polished, molded, or the like.

It will be understood that the Truncated Parabolic Reflector can include other components, elements, or interfaces without departing from the scope of the present disclosure. Furthermore, although particular embodiments have been discussed above, the disclosure is not limited to the disclosed embodiments, but includes subject matter encompassed by the scope of the appended claims.

It will be understood that, although certain embodiments employing particular materials and forms of adjustment are illustrated, other materials and forms of adjustment can be used without departing from the present scope of the disclosure. For example, adhesives between portions of the Reflector can be used as a form of attachment. In addition, various arrangements of particular components can be employed to accomplish the same functions disclosed herein, also without departing from the present scope of the disclosure.

What is claimed is:

1. An apparatus comprising:
a sheet of material having a generally circular shape, and having a central opening substantially at a center of the sheet of material, the opening configured to be placed around a base of a leafy plant;
the sheet of material further having a slit extending from the central opening, through the sheet of material, such that a first portion of the sheet of material proximate to a first edge of the slit can be joined to a second portion of the sheet of material proximate to a second edge of the slit, thereby bending the sheet of material into a shape having a truncated quadric surface; and
wherein the at least one side of the sheet of material is adapted to reflect a targeted spectrum of electromagnetic radiation upwards to irradiate a bottom surface of a leaf of the leafy plant.

2. The apparatus of claim 1, the at least one side of the sheet of material exhibiting substantially diffuse reflectance of the targeted spectrum of electromagnetic radiation.

3. The apparatus of claim 1, comprising:
a cover having an opening at its center and a slit that enables the cover to be fitted around the base of the plant, the cover shaped and sized to substantially cover the central opening of the sheet of material; and
the cover and the sheet of material cooperating to funnel water down the truncated quadric surface and under the cover while minimizing soil splash.

4. The apparatus of claim 1, the first portion of the sheet of material proximate to the first edge of the slit joined to the second portion of the sheet of material proximate to the second edge of the slit by at least one tab on the first portion of the sheet of material coupled to at least one slot on the second portion of the sheet of material.

5. The apparatus of claim 1, the first portion of the sheet of material proximate to the first edge of the slit joined to the second portion of the sheet of material proximate to the second edge of the slit by at least one pair of adhesive tabs adapted to couple to each other.

6. The apparatus of claim 1, the first portion of the sheet of material proximate to the first edge of the slit joined to the second portion of the sheet of material proximate to the second edge of the slit by at least one pair of snap closures adapted to couple to each other.

7. The apparatus of claim 1, comprising at least one reflective surface coupled to the sheet of material, the at least one reflecting surface adapted to repel pests from the at least one leafy plant.

8. The sheet of material of claim 1 further comprising at least one hole to receive at least part of a support member comprising a leafy plant support structure.

9. An apparatus for stimulating plant growth comprising:
an outer dish generally in the shape of a truncated cone, the dish having an inner surface, an outer surface, an open top portion, and an open bottom portion, such that the open bottom portion is disposed around a base of a plant, and the inner surface reflects a targeted spectrum of electromagnetic radiation upwards to irradiate a bottom surface of a leaf of the plant;
a cover shaped and sized to cover the open bottom portion of the outer dish, and having an opening to allow the cover to be placed around the base of the plant; and
the cover and the outer dish cooperating to funnel water down the inner surface of the outer dish and under the cover to a root of the plant, while minimizing soil splash.

10. The apparatus of claim 9, the inner surface facilitating diffuse reflection of the targeted spectrum of electromagnetic radiation and shading of soil proximate to the plant.

11. The apparatus of claim 9, the outer dish having a slit that extends substantially from the open top portion to the open bottom portion, such that a first portion of the outer dish proximate to a first edge of the slit can be joined to a second portion of the outer dish proximate to a second edge of the slit, thereby bending the outer dish into a shape having a truncated quadric surface.

12. The apparatus of claim 11, the first portion of the outer dish proximate to the first edge of the slit joined to the second portion of the outer dish proximate to the second edge of the slit by at least one pair of adhesive tabs adapted to couple to each other.

13. The apparatus of claim 11, the first portion of the outer dish proximate to the first edge of the slit joined to the second portion of the outer dish proximate to the second edge of the slit by at least one tab on the first portion of the outer dish coupled to at least one slot on the second portion of the outer dish.

14. The apparatus of claim 9, comprising at least one reflective surface coupled to the outer dish, the at least one reflecting surface adapted to antagonize pests in proximity to the at least one plant.

15. The outer dish of claim 9 further comprising at least one hole to receive at least part of a support member comprising a plant support structure.

16. The outer dish of claim 9 impregnated with at least one substance to mitigate the reflection of spectra of electromagnetic radiation other than the targeted spectrum of electromagnetic radiation.

17. A reflector for use in growing plants, the reflector comprising:
an adjustable funnel comprising a mouth and an apex, the adjustable funnel having a generally parabolic surface adapted to reflect a substantially limited spectrum of light onto a bottom surface of a leaf of a plant about which the adjustable funnel is placed;
an apex cover adapted to be placed around a base of the plant, and to substantially cover an opening in the apex of the adjustable funnel;
the apex cover and the adjustable funnel cooperating to funnel water to roots of the plant while minimizing soil splash.

18. The reflector of claim 17, the generally parabolic surface facilitating diffuse reflection of the substantially limited spectrum of light.

19. The reflector of claim 17, a first portion of the adjustable funnel joined to a second portion of the adjustable funnel by at least one tab on the first portion of the adjustable funnel coupled to at least one slot on the second portion of the adjustable funnel to bend the adjustable funnel into a shape having a truncated quadric surface.

20. The adjustable funnel of claim 17 further comprising at least one hole to receive at least part of a support member comprising a plant support structure.
